(19) United States
(12) Patent Application Publication
(10) Pub. No.: US 2007/0062322 A1
(43) Pub. Date: Mar. 22, 2007

(54) Apparatus and method for emergency brake cable removal from and installation onto parking brake lever

(76) Inventors: J.C. Duffey, Alexandria, LA (US); J.C. Duffey, Alexandria, LA (US)

Correspondence Address: JAMES RAY & ASSOCIATES, 2640 PITCAIRN ROAD, MONROEVILLE, PA, 15146, US

(21) Appl. No.: 11/230,735

(22) Filed: Sep. 20, 2005

(51) Int. Cl. F16C 1/10

(52) U.S. Cl. 74/500.5

(57) ABSTRACT

Device to remove and reinstall parking brake cable onto a parking brake lever. The brake cable includes a cable in a spiral spring and a cable end stop member. The brake lever has a cable engaging portion caged between the end stop member and an end portion of the spring. The device includes a first member having a bifurcated first end engageable with the spring and a second member having a clamp engageable with the end stop for securing it during use. A threaded elongated member is engageable with the second member and connected to the first member for moving it at least away from the second member to separate the end of the spring from the brake lever and disengage it from the cable. An elongated member outwardly extends from the second member and engages a second end of the first member for moving it in a linear direction.

### FIELD OF THE INVENTION

The present invention relates, in general, to a hand tool for use on automotive vehicles and, more particularly, this invention relates to a hand tool for parking brake cable removal from and installation onto a parking brake lever.

### BACKGROUND OF THE INVENTION

As is generally well known, a parking or emergency brake system in an automotive vehicle employs braking cables attached to a brake handle or brake pedal at one end and to a parking brake lever mechanism at a distal end. The parking brake cable includes a helical coiled spring surrounding the cable member and an end stop member secured to such cable member which, in combination, cage a portion of the parking brake lever mechanism and apply a substantial compressive force onto such portion of the parking brake lever mechanism. Actuation of the brake cable causes the parking brake lever mechanism to urge brake shoes into engagement with a brake drum or rotor, thus providing the braking force during manual brake actuation.

It is often required first to disengage the brake cable from the parking brake lever mechanism during repair or replacement of the brakes and then reengage the brake cable onto the parking brake lever mechanism when such repair or replacement is completed. The substantial compressive forces acting on such parking brake lever mechanism must be overcome in order to remove and replace such brake cable. The removal effort is generally difficult for one person to perform.

Efforts have been made to reduce the effort required for removal and replacement of the brake cable by providing special tools. U.S. Pat. No. 4,738,017 to Teramo discloses locking pliers secured onto the end stop member and a prying device secured to one of the handle members of the locking pliers. The prying device has a lever arm with a bifurcated generally pointed blade like end portion for partially collaring the brake cable. The lever arm is pivoted in a first direction to move the end of the helical coiled spring away from such end stop member in order to remove the compressive force acting on such parking brake lever mechanism. The lever arm returns to its original position after removal of the brake cable and must be pivoted again during reinstallation of the brake cable which adds to the complexity of the removal and reinstallation effort.

### SUMMARY OF THE INVENTION

The invention provides an apparatus and method for parking brake cable removal from and installation onto the parking brake lever during repair or replacement of the brake system. The parking brake cable includes a cable, a coiled spiral spring surrounding the cable, and a cable end stop member. The parking brake lever has a portion thereof engaging the cable and caged between the cable end stop member and an end portion of the coiled spiral spring. The apparatus includes a first member having a bifurcated first end with a beveled portion formed therein for engagement with the coiled spiral spring. The bifurcated end is rotated for alignment with a direction of the spiral coil turns of the coiled spiral spring. A second member has a clamp engageable with the cable end stop member for applying a clamping force to such cable end stop member and securing it during use of such apparatus. A threaded elongated member is engageable with the second member and connected to the first member for moving it at least away from the second member to separate the end of the coiled spring from the parking brake lever and disengage such parking brake lever from the cable. Such separation is maintained during the repair or replacement of the brake system. A free end of the threaded elongated member is equipped with a substantially spherical grip member. An elongated member outwardly extends from the second member and engages a second end of the first member for guiding its movement in a substantially linear direction and for preventing its rotation during such linear movement.

### OBJECTS OF THE INVENTION

It is, therefore, one of the primary objects of the present invention to provide an apparatus and method for parking brake cable removal from and installation onto the parking brake lever.

Another object of the present invention is to provide an apparatus and method for parking brake cable removal from and installation onto the parking brake lever which can be easily performed by one person.

A further object of the present invention is to provide an apparatus for parking brake cable removal from and installation onto the parking brake lever which maintains separation of the coiled spiral spring from an end stop member.

An additional object of the present invention is to provide an apparatus for parking brake cable removal from and installation onto the parking brake lever which is economical to manufacture.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a plan view of the parking brake cable apparatus of the present invention;

FIG. 2 is a front elevation view of the parking brake cable apparatus of the present invention;

FIG. 3 is a partial side elevation view of the parking brake cable apparatus of the present invention;

FIG. 4 is a partial plan view of the parking brake cable apparatus of the present invention showing its engagement with the brake cable and parking brake lever.

### BRIEF DESCRIPTION OF THE VARIOUS EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

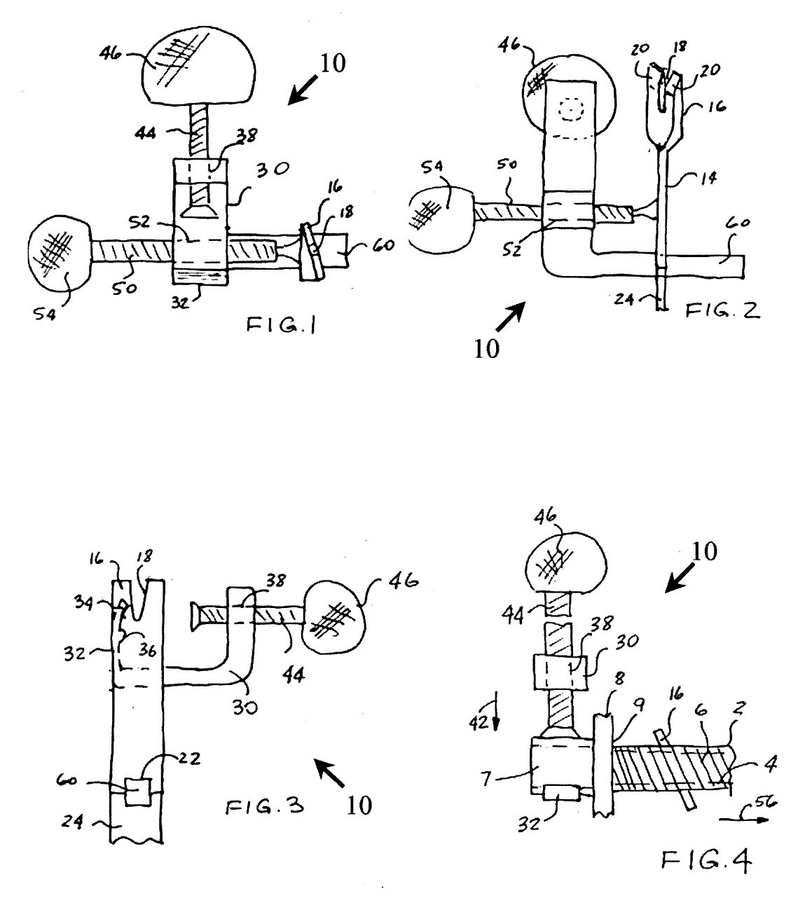

Reference is now made, to FIGS. 1-4, wherein there is shown an apparatus, generally designated 10, for removal and installation of a parking brake cable 2 from and onto, respectively, the parking brake lever 8. In particular reference to FIG. 4, the parking brake cable 2 includes a cable 4, a coiled spiral spring 6 surrounding the cable 4 and a cable end stop member 7. The parking brake lever 8 has a predetermined portion 9 engaging the cable 4 and caged between the cable end stop member 7 and an end portion of the coiled spiral spring 6.

Such apparatus 10 includes a first member 14 having a bifurcated end 16 of a predetermined width and a predetermined thickness with an elongated aperture 18 formed therein. Preferably, the bifurcated end 16 is rotated at a predetermined angle and is aligned with a direction of the spiral coil turns of the coiled spiral spring 6. It is further preferred that a beveled portion 20 is formed within the predetermined thickness providing for a blade like bifurcated end 16 to facilitate engagement thereof between one of the predetermined portion 9 of the parking brake lever 8 and the end portion of the coiled spiral spring 6 or any two spiral coil turns of the coiled spiral spring 6. The beveled portion 20 may be formed at either surface of the bifurcated end 16.

A second member 30 is provided for engagement with and secure attachment to the cable end stop member 7. Such second member 30 of the presently preferred embodiment is a clamp 30 for caging and securing the cable end stop member 7 therein. Such clamp 30 has a fixed end 32 and a movable portion 40 movable in a direction 42 towards the fixed end 32 to apply a clamping force onto the cable end stop member 7. Such clamping force will secure the cable end stop member 7 within the clamp 30. Preferably, such force is applied in a direction substantially perpendicular to the longitudinal axis of the cable 4.

The movable portion 40 has a threaded elongated member 44 engaging a threaded aperture 38 provided within such clamp 30 and disposed substantially perpendicular to such fixed end 32. A first end of the threaded elongated member 44 is adapted for engagement with a surface of the cable end stop member 7. A second end of the threaded elongated member 44 has grip means 46 attached thereto for facilitating application of such clamping force. Such grip means is one of a substantially spherical member and a handle like member and is provided with one of serration, texture and knurl formed on an outer surface thereof for substantially minimizing slippage during application of the clamping force.

A free edge 34 of the fixed portion 30 is curved inwardly and a raised tab portion 36 is formed in such fixed end 30 in spaced relationship with such edge 34 for facilitating caging of the cable end stop member 7.

A threaded elongated member 50 threadably engages a threaded aperture 52 disposed within the second member 30 and has a first end pivotally connected to the first member 14 for moving such first member 14 at least away from the second member 30. Preferably, a longitudinal axis of such threaded elongated member 52 is generally aligned with the longitudinal axis of the cable 4. A second end of the threaded elongated member 52 has grip means 54 attached thereto for facilitating movement of the first member 14 at least away from the second member 30.

The apparatus 10 further includes an elongated member 60 which extends outwardly from the second member 30 and an aperture 22 formed within the first member 14 opposite the bifurcated end 16 and engaging the elongated member 60 for guiding movement of such first member 14. Advantageously, such combination of the elongated member 60 and the aperture 22 enables substantially linear movement of the first member 14 and prevents rotation thereof.

Preferably, the elongated member 60 and the second member 30 are formed as a single piece casting.

Operation of the apparatus 10 is best illustrated in FIG. 4. First, the bifurcated end 16 of the first member 14 is inserted either between the predetermined portion 9 of the parking brake lever 8 and the end portion of the coiled spiral spring 6 or between any two spiral coil turns of the coiled spiral spring 6. Such front portion 14 may be provided with additional grip portion 24 extending away from the elongated member 60 for facilitating the insertion effort. The second member 30 is than aligned with the cable end stop member 7, caging it between the fixed end 32 and the end of the threaded elongated member 44. The clamping force is applied to such cable end stop member 7 by rotating the grip means 46 causing the rotation of the threaded elongated member 44.

The first member 14 is then moved away from the second member 30 in a direction 56 by using the threaded elongated member 50 and grip means 54 to separate the end of the coiled spiral spring 6 from the predetermined portion 9 of the parking brake lever 8 and remove the parking brake cable 2 from engagement therewith. Advantageously, such separation will be maintained during repair or replacement effort.

To reengage the end portion of the coiled spiral spring 6 with the predetermined portion 9 of the parking brake lever 8, rotation of the grip means 54 in the opposite direction causes movement of the first member 14 towards the second member 30. Such second member 30 is then disengaged from the cable end stop member 7 by rotating the threaded elongated member 44 in the opposite direction and discontinuing application of the clamping force.

Although the present invention has been shown in terms of the clamping force provided by a threaded arrangement, it will be apparent to those skilled in the art, that other well known clamping types may be applied in the present invention to provide such clamping force. For example, a lever type clamp or a ratchet type clamp may provide adequate clamping force.

A ratchet type mechanism may be further used to move the first member and to maintain the separation between the coiled spiral spring and the parking brake lever.

Additionally, the second member of the presently preferred embodiment may be provided with a handle for ease of handling such apparatus during caging and securement of the cable end stop member.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

We claim:

1. A method for at least removing an automotive parking brake cable from an associated parking brake lever, said automotive parking brake cable including a cable, a coiled spiral spring surrounding said cable, and a cable end stop member, said parking brake lever having a predetermined portion thereof engaging said cable and caged between said cable end stop member and an end portion of said coiled spiral spring, said method comprising the steps of:
(a) inserting a first member of a tool between one of said predetermined portion of said parking brake lever and said end portion of said coiled spiral spring and any two spiral coil turns of said coiled spiral spring;
(b) aligning a second member of said tool with said cable end stop member, said second member is connected to said first member;
(c) securing said cable end stop member within said second member of said tool;
(d) moving said first member of said tool away from said second member to separate said end of said coiled spiral spring from said predetermined portion of said parking brake lever;
(e) maintaining a separation of said coiled spiral spring with said predetermined portion of said parking brake lever; and
(f) removing said cable from engagement with said parking brake lever.

2. The method, according to claim 1, wherein said method includes a step of moving said first member of said tool towards said second member to reengage said end portion of said coiled spiral spring with said predetermined portion of said parking brake lever.

3. The method, according to claim 2, wherein said method further includes a step of disengaging said second member from said cable end stop member.

4. An apparatus for at least removing an automotive parking brake cable from an associated parking brake lever, said automotive parking brake cable including a cable, a coiled spiral spring surrounding said cable, and a cable end stop member, said parking brake lever having a predetermined portion thereof engaging said cable and caged between said cable end stop member and an end portion of said coiled spiral spring, said apparatus comprising:
(a) a first member engageable with at least a portion of said coiled spiral spring;
(b) a second member engageable with said cable end stop member;
(c) means connected to said first member and engageable with said second member for moving said first member at least away from said second member; and
(d) means engageable with said first member and connected to said second member for guiding movement of said first member.

5. The apparatus, according to claim 4, wherein said first member includes a bifurcated end having each of a predetermined width and predetermined thickness for engagement between one of said predetermined portion of said parking brake lever and said end portion of said coiled spiral spring and any two spiral coil turns of said coiled spiral spring.

6. The apparatus, according to claim 5, wherein said bifurcated end is rotated at a predetermined angle and aligned with a direction of said spiral coil turns of said coiled spiral spring.

7. The apparatus, according to claim 5, wherein a beveled portion formed within said predetermined thickness provides for a blade like bifurcated end to facilitate engagement thereof between said one of said predetermined portion of said parking brake lever and said end portion of said coiled spiral spring and said any two spiral coil turns of said coiled spiral spring.

8. The apparatus, according to claim 7, wherein said beveled portion is disposed one of towards and away from said second member.

9. The apparatus, according to claim 4, wherein said second member includes a clamp means for caging and securing said cable end stop member therein.

10. The apparatus, according to claim 9, wherein said clamp means includes a fixed end and a movable end movable in a first direction towards said fixed end to apply a force onto said cable end stop member, said force securing said cable end stop member within said clamp means.

11. The apparatus, according to claim 10, wherein said clamp means further includes a grip means attached to said movable end for facilitating application of said force.

12. The apparatus, according to claim 10, wherein said grip means is one of a substantially spherical member and a handle like member.

13. The apparatus, according to claim 12, wherein an outer surface of said grip means includes one of serrations, texture and knurl formed thereon for substantially minimizing slippage.

14. The apparatus, according to claim 4, wherein said means for moving said first member includes a threaded elongated member threadedly engaging a threaded aperture disposed within said second member.

15. The apparatus, according to claim 14, wherein said means for moving said first member further includes a grip means attached to a second end thereof.

16. The apparatus, according to claim 4, wherein said means for moving said first member is pivotally attached thereto.

17. The apparatus, according to claim 4, wherein said guiding means includes an elongated member extending outwardly from said second member and an aperture disposed within said first member opposite said bifurcated end thereof and engaging said elongated member for maintaining substantially linear movement of said first member.

18. The apparatus, according to claim 17, wherein said elongated member is integral to said second member.

19. The apparatus, according to claim 17, wherein said elongated member and said second member are formed as a single piece casting.
